(19) United States
(12) Patent Application Publication
(10) Pub. No.: US 2022/0359108 A1
(43) Pub. Date: Nov. 10, 2022

(54) NON-ORIENTED ELECTRICAL STEEL SHEET, METHOD FOR PRODUCING THE SAME, AND MOTOR CORE

(71) Applicant: JFE Steel Corporation, Tokyo (JP)

(72) Inventors: Takaaki Tanaka, Chiyoda-ku, Tokyo (JP); Tomoyuki Okubo, Chiyoda-ku, Tokyo (JP); Yoshiaki Zaizen, Chiyoda-ku, Tokyo (JP); Yoshihiko Oda, Chiyoda-ku, Tokyo (JP); Yukino Miyamoto, Chiyoda-ku, Tokyo (JP)

(73) Assignee: JFE Steel Corporation, Tokyo (JP)

(21) Appl. No.: 17/619,838

(22) PCT Filed: Jul. 7, 2020
(86) PCT No.: PCT/JP2020/026599

§ 371 Date: Dec. 16, 2021

(30) Foreign Application Priority Data
Jul. 11, 2019 (JP) 2019-129224

(51) Int. Cl. H01F 1/147; C22C 38/18; C22C 38/16; C22C 38/14; C22C 38/12; C22C 38/08; C22C 38/06; C22C 38/04; C22C 38/34; C22C 38/00; C21D 9/46; C21D 8/02; C21D 6/00; H02K 1/02

(52) U.S. Cl. CPC H01F 1/14775; C22C 38/18; C22C 38/16; C22C 38/14; C22C 38/12; C22C 38/08; C22C 38/06; C22C 38/04; C22C 38/34; C22C 38/008; C22C 38/005; C22C 38/002; C22C 38/001; C21D 9/46; C21D 8/0226; C21D 8/0236; C21D 8/0205; C21D 6/008; C21D 6/005; C21D 6/002; C21D 6/001; H02K 1/02

(57) ABSTRACT

Provided is a non-oriented electrical steel sheet having an average crystal grain size of crystal grains being not more than 80 μm, an area ratio of crystal grains having a grain size of not less than 1.5 times the average crystal grain size being not less than 10%; and an area ratio of crystal grains having aspect ratios of not more than 0.3 being not more than 20%, by subjecting a steel raw material containing, in mass %, C: not more than 0.005%, Si: 2.0 to 5.0%, Mn: 0.05 to 5.0%, Al: not more than 3.0%, and Zn: 0.0003 to 0.0050% to hot rolling, cold rolling, and cold-rolled sheet annealing and by heating the cold-rolled sheet to an annealing temperature between 700 to 850° C. at the average heating rate between 500 and 700° C. in a heating process of the cold-rolled sheet annealing to be not less than 10° C./s.

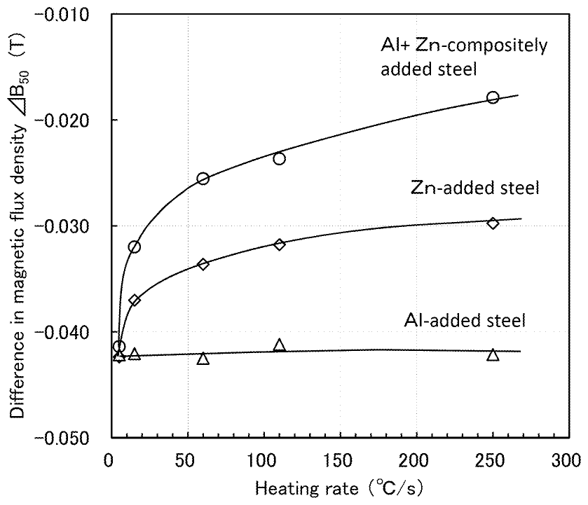

### CROSS REFERENCE TO RELATED APPLICATIONS

This is the U.S. National Phase application of PCT/JP2020/026599 filed Jul. 7, 2020, which claims priority to Japanese Patent Application No. 2019-129224, filed Jul. 11, 2019 the disclosures of these applications being incorporated herein by reference in their entireties for all purposes.

### FIELD OF THE INVENTION

The present invention relates to a non-oriented electrical steel sheet, a method for producing the same, and a motor core constituted of the steel sheet.

### BACKGROUND OF THE INVENTION

Along with the increasing demand for electrical equipment towards energy saving in recent years, non-oriented electrical steel sheets to be used for iron cores of rotating machines have been required to have more excellent magnetic properties. To meet requirements for smaller size and higher output in driving motors and the like of HEV (hybrid vehicles) and EV (electric vehicles), the driving frequency has been recently increased to increase the rotation number of motors.

A motor core comprises a stator core and a rotor core. A rotor core of HEV driving motors has a large outer diameter, causing a large centrifugal force to be exerted thereon. Further, a rotor core has a very narrow portion (1 to 2 mm) called a rotor core bridge portion due to its structure, and the portion gets in an especially high-stress state during driving of the motor. Further, since the motor rotates and stops repeatedly, the rotor core is subjected to large repetitive stress due to centrifugal force, so the electrical steel sheet used for the rotor core needs to have excellent fatigue characteristics.

On the other hand, to attain the smaller size and higher output of a motor, electrical steel sheets to be used for a stator core are desired to have a high magnetic flux density and a low iron loss. That is, electrical steel sheets to be used for motor cores ideally should have such properties as high-fatigue properties when used for rotor cores and a high magnetic flux density and a low iron loss when used for stator cores.

Thus, an electrical steel sheet is required to have very different properties depending on the use for a rotor core or use for a stator core, even when used for the same motor core. From the viewpoint of production of motor cores, however, to enhance the material yield and productivity, a rotor core material and a stator core material should be taken out from the same raw material steel sheet, and each material is laminated and assembled into each of a rotor core and a stator core.

Techniques of producing a non-oriented electrical steel sheet being high in strength and low in an iron loss for motor cores include, for example, Patent Literature 1; Patent Literature 1 discloses a method of producing a rotor core with high strength and a stator core with a low iron loss including producing a high-strength non-grain oriented electrical steel sheet, taking out a rotor core material and a stator core material from the steel sheet by blanking, laminating and assembling each core material into a rotor core and a stator core, and thereafter subjecting only the stator core to stress-relief annealing.

### PATENT LITERATURE

Patent Literature 1: Japanese Patent Laid-Open No. 2008-50686

### SUMMARY OF THE INVENTION

According to studies by the inventors, however, the method disclosed in Patent Literature 1, poses such a problem; although using a high-strength non-oriented electrical steel sheet can increase the yield stress, the fatigue strength being the most important property, is not always improved, and although the iron loss after the stress-relief annealing is largely improved, the magnetic flux density is greatly reduced in some cases.

Aspects of the present invention have been developed in consideration of the above problem inherent to the conventional techniques and have an object to provide a non-oriented electrical steel sheet from which a rotor core material to be required to have high strength and a high fatigue property and a stator core material to be required to have more excellent magnetic properties can be taken out from the same material and a method for producing the same, and a motor core constituted with the non-oriented electrical steel sheet.

To solve the above problem, the inventors conducted studies especially focusing on the component composition of steel, particularly to Zn. As a result, they have found that a non-oriented electrical steel sheet having a high fatigue strength as well as exhibiting little lowering of the magnetic flux density in subsequent heat treatment can be obtained, by adding a suitable amount of Zn and further carrying out cold-rolled sheet annealing under suitable conditions to thus control the crystal grain size and the nonuniformity thereof, and thus finally have accomplished the present invention.

[1] Aspects of the present invention based on the above finding include a non-oriented electrical steel sheet, characterized by having

a component composition comprising C: not more than 0.005 mass %, Si: not less than 2.0 mass % and not more than 5.0 mass %, Mn: not less than 0.05 mass % and not more than 5.0 mass %, P: not more than 0.1 mass %, S: not more than 0.01 mass %, Al: not more than 3.0 mass %, N: not more than 0.0050 mass %, Zn: not less than 0.0003 mass % and not more than 0.0050 mass %, and the residue being Fe and inevitable impurities,

an average crystal grain size of not more than 80 μm,

an area ratio of crystal grains having a grain size of not less than 1.5 times the average crystal grain size being not less than 10%, and

an area ratio of crystal grains having an aspect ratio of not more than 0.3 being not more than 20%.

[2] The non-oriented electrical steel sheet according to aspects of the present invention is characterized by containing, in addition to the above component composition, at least one component group selected from the following Groups A to E:
Group A; Cr: not less than 0.1 mass % and not more than 5.0 mass %;
Group B; one or two or more of Ca: not less than 0.001 mass % and not more than 0.01 mass %, Mg: not less than 0.001 mass % and not more than 0.01 mass %, and REM: not less than 0.001 mass % and not more than 0.01 mass %;
Group C; one or two of Sn: not less than 0.001 mass % and not more than 0.2 mass %, and Sb: not less than 0.001 mass % and not more than 0.2 mass %;
Group D; Ni: not less than 0.01 mass % and not more than 3.0 mass %; and
Group E; one or two or more of Cu: not less than 0.05 mass % and not more than 0.5 mass %, Nb: not less than 0.003 mass % and not more than 0.05 mass %, Ti: not less than 0.003 mass % and not more than 0.05 mass %, and V: not less than 0.010 mass % and not more than 0.20 mass %.

[3] The non-oriented electrical steel sheet according to aspects of the present invention is characterized by having

a component composition comprising C: not more than 0.005 mass %, Si: not less than 2.0 mass % and not more than 5.0 mass %, Mn: not less than 0.05 mass % and not more than 5.0 mass %, P: not more than 0.1 mass %, S: not more than 0.01 mass %, Al: not more than 3.0 mass %, N: not more than 0.0050 mass %, Zn: not less than 0.0003 mass % and not more than 0.0050 mass %, and the residue being Fe and inevitable impurities,

an average crystal grain size being not less than 120 μm, and

an area ratio of crystal grains having a grain size of not less than 1.5 times the average crystal grain size being not less than 5%.

[4] The non-oriented electrical steel sheet according to aspects of the present invention is characterized by having, in addition to the above component composition, at least one component group selected from the following Groups A to E:
Group A; Cr: not less than 0.1 mass % and not more than 5.0 mass %;
Group B; one or two or more of Ca: not less than 0.001 mass % and not more than 0.01 mass %, Mg: not less than 0.001 mass % and not more than 0.01 mass %, and REM: not less than 0.001 mass % and not more than 0.01 mass %;
Group C; one or two of Sn: not less than 0.001 mass % and not more than 0.2 mass %, and Sb: not less than 0.001 mass % and not more than 0.2 mass %;
Group D; Ni: not less than 0.01 mass % and not more than 3.0 mass %; and
Group E; one or two or more of Cu: not less than 0.05 mass % and not more than 0.5 mass %, Nb: not less than 0.003 mass % and not more than 0.05 mass %, Ti: not less than 0.003 mass % and not more than 0.05 mass %, and V: not less than 0.010 mass % and not more than 0.20 mass %.

[5] Aspects of the present invention include a method for producing a non-oriented electrical steel sheet including

hot rolling a steel raw material having a component composition comprising C: not more than 0.005 mass %, Si: not less than 2.0 mass % and not more than 5.0 mass %, Mn: not less than 0.05 mass % and not more than 5.0 mass %, P: not more than 0.1 mass %, S: not more than 0.01 mass %, Al: not more than 3.0 mass %, N: not more than 0.0050 mass %, Zn: not less than 0.0003 mass % and not more than 0.0050 mass %, and the residue being Fe and inevitable impurities to form a hot-rolled sheet;

pickling and cold rolling the hot-rolled sheet to form a cold-rolled sheet; and

subjecting the cold-rolled sheet to cold-rolled sheet annealing, wherein

the steel sheet is heated to an annealing temperature T₁ between 700° C. and 850° C. at an average heating rate V₁ of not less than 10° C./s from 500° C. to 700° C. in a heating process of the cold-rolled sheet annealing and cooled so that the non-oriented electrical steel sheet has an average crystal grain size of not more than 80 μm, an area ratio of crystal grains having a grain size of not less than 1.5 times the average crystal grain size of 10%, and an area ratio of crystal grains having an aspect ratio of not more than 0.3 being not more than 20%.

[6] The steel raw material to be used in the method for producing a non-oriented electrical steel sheet according to aspects of the present invention contains, in addition to the above component composition, at least one component group selected from following Groups A to E:
Group A; Cr: not less than 0.1 mass % and not more than 5.0 mass %;
Group B; one or two or more of Ca: not less than 0.001 mass % and not more than 0.01 mass %, Mg: not less than 0.001 mass % and not more than 0.01 mass %, and REM: not less than 0.001 mass % and not more than 0.01 mass %;
Group C; one or two of Sn: not less than 0.001 mass % and not more than 0.2 mass %, and Sb: not less than 0.001 mass % and not more than 0.2 mass %;
Group D; Ni: not less than 0.01 mass % and not more than 3.0 mass %; and
Group E; one or two or more of Cu: not less than 0.05 mass % and not more than 0.5 mass %, Nb: not less than 0.003 mass % and not more than 0.05 mass %, Ti: not less than 0.003 mass % and not more than 0.05 mass %, and V: not less than 0.010 mass % and not more than 0.20 mass %.

[7] The method for producing a non-oriented electrical steel sheet according to aspects of the present invention is characterized by further performing a heat treatment including heating the non-oriented electrical steel sheet after the cold-rolled sheet annealing described in [5] or [6] to an annealing temperature T₂ between 750 to 900° C. and holding the annealing temperature, so that the non-oriented electrical steel sheet has an average crystal grain size of not less than 120 μm, and an area ratio of crystal grains having a grain size of not less than 1.5 times the average crystal grain size being not less than 5%.

[8] Aspects of the present invention include a motor core comprising a rotor core constituted of the non-oriented electrical steel sheet in [1] or [2], and a stator core constituted of the non-oriented electrical steel sheet in [3] or [4].

Aspects of the present invention enable a rotor core material having a high strength and a high fatigue strength and a stator core material excellent in the magnetic properties to be taken out from the same non-oriented electrical steel sheet, allowing to produce a high-performance motor core with high material yield and low costs.

### BRIEF DESCRIPTION OF THE DRAWING

The FIGURE is a graph showing an influence of an average heating rate between 500 to 700° C. in a heating process of a cold-rolled sheet annealing upon a deterioration quantity ΔB₅₀ of magnetic flux density by heat treatment.

### DETAILED DESCRIPTION OF EMBODIMENTS OF THE INVENTION

There will be first described the component composition of a non-oriented electrical steel sheet according to aspects of the present invention, and the reason for limitation thereof. In accordance with aspects of the present invention, a steel raw material to be used for the production of a non-oriented electrical steel sheet and a product sheet therefrom have the same component composition.

C: not more than 0.005 mass %

C is a harmful element that forms carbide during the motor is used, causing magnetic aging and deterioration of iron loss properties. To avoid magnetic aging, C contained in the steel raw material needs to be not more than 0.005 mass %. Preferably, C is not more than 0.004 mass %. Here, the lower limit of C is not particularly specified, but from the viewpoint of reducing the decarburization cost in a steelmaking step, C is preferably about 0.0001 mass %.

Si: not less than 2.0 mass % and not more than 5.0 mass %

Si is an element essential to increase the specific resistance of steel and reduce iron loss; is also an element that raises the strength of steel through solid-solution strengthening. To attain the above effect, in accordance with aspects of the present invention, Si is added by not less than 2.0 mass %. On the other hand, since the addition of more than 5.0 mass % thereof decreases the saturation magnetic flux density and remarkably decreases the magnetic flux density, the upper limit is set to 5.0 mass %; it is preferably in the range of not less than 2.5 mass % and not more than 5.0 mass %, and more preferably not less than 3.0 mass % and not more than 5.0 mass %.

Mn: not less than 0.05 mass % and not more than 5.0 mass %

Mn is, similarly to Si, an element useful to increase the specific resistance and strength of steel. To attain these effects, Mn is added by not less than 0.05 mass %. On the other hand, the addition of Mn exceeding 5.0 mass % may promote the precipitation of MnC and deteriorate the magnetic properties, and thus the upper limit is set to 5.0 mass %. The addition of Mn is preferably in the range of not less than 0.1 mass % and not more than 3.0 mass %.

P: not more than 0.1 mass %

P is an element effectively used for the regulation of the strength (hardness) of steel. However, since the addition exceeding 0.1 mass % decreases the toughness and easily causes cracks during work, the upper limit is set to be 0.1 mass %. Then, the lower limit is not particularly specified, but since an excessive reduction of P brings about a rise in production costs, P is made to be about 0.001 mass %; it is preferably in the range of not less than 0.005 mass % and not more than 0.08 mass %.

S: not more than 0.01 mass %

S is a harmful element that forms and precipitates fine sulfide and adversely affects iron loss properties. In particular, since the S content exceeding 0.01 mass % causes remarkable adverse effects, S is restricted to not more than 0.01 mass %; it is preferably not more than 0.005 mass %.

Al: not more than 3.0 mass %

Similar to Si, Al is an element useful to increase the specific resistance of steel and reduce the iron loss thereof. Al also has, when added in combination with Zn, an effect of strengthening the effect of changing the nonuniformity of the crystal grain size by the addition of Zn after the cold-rolled sheet annealing or heat treatment, by properly combining the Zn addition and the cold-rolled sheet annealing or heat treatment, described later. This allows the fatigue strength of the steel sheet after cold-rolled sheet annealing to increase as well as suppresses the decrease in the magnetic flux density by subsequent heat treatment. To attain such an effect, it is preferable to add Al by not less than 0.005 mass %; it is more preferably by not less than 0.010 mass % and further preferably by not less than 0.015 mass %. On the other hand, since the addition exceeding 3.0 mass % promotes nitriding of the steel sheet surface and may deteriorate the magnetic properties, the upper limit is set to be 3.0 mass %. Preferably, it is not more than 2.0 mass %.

N: not more than 0.0050 mass %

N is a harmful element that forms and precipitates fine nitride and adversely affects iron loss properties. In particular, since the N content exceeding 0.0050 mass % causes the adverse effect to be remarkable, the N content is limited to not more than 0.0050 mass %; it is preferably not more than 0.0030 mass %.

Zn: not less than 0.0003 mass % and not more than 0.0050 mass %

Zn is one of the important elements in accordance with aspects of the present invention; by adding a suitable amount thereof and further carrying out cold-rolled sheet annealing or heat treatment under suitable conditions, there is brought about the effect of changing nonuniformity of the crystal grain size after the cold-rolled sheet annealing or heat treatment. This allows the fatigue strength to increase as well as suppresses the decrease in the magnetic flux density when grain growth is caused by heat treatment. To attain such an effect, Zn needs to be added by not less than 0.0003 mass %; it is preferably by not less than 0.0005 mass %, and more preferably by not less than 0.0008 mass %. On the other hand, since the addition exceeding 0.0050 mass % deteriorates the toughness of a steel sheet and causes fracture during cold rolling, the upper limit is set to be 0.0050 mass %; it is preferably by not more than 0.0030 mass %. Although the reason why the combination of addition of a suitable amount of Zn and suitable cold-rolled sheet annealing or heat treatment causes to vary nonuniformity of the crystal grain size has not yet been clarified sufficiently, the present inventors presume that this is due to changes in driving forces of recrystallization and grain growth.

In the non-oriented electrical steel sheet according to aspects of the present invention, the residue excluding the above components is Fe and inevitable impurities. However, the following components can be further contained according to properties required, in addition to the above component composition.

Cr: not less than 0.1 mass % and not more than 5.0 mass %

Cr has the effects of increasing the specific resistance of steel and reducing iron loss. To attain such effects, Cr is preferably contained by not less than 0.1 mass %. On the other hand, the Cr content exceeding 5.0 mass % brings about a decrease in the saturation magnetic flux density, thus remarkably lowering the magnetic flux density. Hence, in the case of adding Cr, the addition is preferably in the range of not less than 0.1 mass % and not more than 5.0 mass %.

One or two or more of Ca: not less than 0.001 mass % and not more than 0.01 mass %, Mg: not less than 0.001 mass % and not more than 0.01 mass %, and REM: not less than 0.001 mass % and not more than 0.01 mass %

Ca, Mg, and REM all fix S as sulfide and contributes to the reduction of iron loss. To attain such an effect, it is preferable to add Ca, Mg and REM by not less than 0.001 mass % each. On the other hand, since the addition exceeding 0.01 mass % brings about the saturation of the above effects, only causing an increase in the raw material costs, it is preferable to set the upper limit to be 0.01 mass % each.

One or two of Sn: not less than 0.001 mass % and not more than 0.2 mass %, and Sb: not less than 0.001 mass % and not more than 0.2 mass %

Sn and Sb are elements effective to increase the magnetic flux density through the improvement of the texture. To attain such an effect, it is preferable to add each element by not less than 0.001 mass %. On the other hand, since the addition exceeding 0.2 mass % brings about the saturation of the effect, only causing an increase in the raw material costs, it is preferable to set the upper limit of each element to be 0.2 mass %.

Ni: not less than 0.01 mass % and not more than 3.0 mass %

Ni is an element effective to increase the magnetic flux density. To attain the above effect, it is preferable to add the element by not less than 0.01 mass %. However, since the addition exceeding 3.0 mass % brings about the saturation of the above effect, only causing an increase in the raw material costs, it is preferable to set the upper limit to be 3.0 mass %.

One or two or more of Cu: not less than 0.05 mass % and not more than 0.5 mass %, Nb: not less than 0.003 mass % and not more than 0.05 mass %, Ti: not less than 0.003 mass % and not more than 0.05 mass %, and V: not less than 0.010 mass % and not more than 0.20 mass %

Cu, Nb, Ti, and V are elements that precipitate in steel independently or in a form of carbide, nitride or carbonitride, and contribute to the improvement of the strength and the fatigue strength of a steel sheet. To attain such effects, it is preferable to add Cu by not less than 0.05 mass % Nb and Ti by not less than 0.003 mass % each, and V by not less than 0.010 mass %. However, since the addition of Cu exceeding 0.5 mass %, Nb and Ti each exceeding 0.05 mass % and V exceeding 0.20 mass % inhibit grain growth during heat treatment and deteriorate the iron loss in some cases, it is preferable to set the upper limits to be Cu: 0.5 mass %, Nb and Ti: 0.05 mass % and V: 0.20 mass %. However, in the case where the magnetic properties are considered important rather than the strength and the fatigue strength of a steel sheet, it is preferable to limit Cu to not more than 0.02 mass %, Nb to not more than 0.0005 mass %, Ti to not more than 0.0010 mass % and V to not more than 0.0010 mass %.

Then, the microstructure of a non-oriented electrical steel sheet according to aspects of the present invention will be described.

First, the non-oriented electrical steel sheet after cold-rolled sheet annealing described in [1] or [2] will be explained.

Average Crystal Grain Size: Not More than 80 μm

According to studies by the present inventors, the steel sheet after cold-rolled sheet annealing is, by making the average crystal grain size fine, improved in the fatigue strength. In particular, when the average crystal grain size is not more than 80 μm, there can be secured the fatigue strength of not less than 450 MPa required as a rotor core material of HEV/EV motors. Hence, in the non-oriented electrical steel sheet to be used for the rotor core according to aspects of the present invention, the average crystal grain size is limited to not more than 80 μm.

Crystal Grains Having a Grain Size of not Less than 1.5 Times the Average Crystal Grain Size: Not Less than 10% in the Area Ratio

The inventors have acquired new knowledge that a non-oriented electrical steel sheet having an excellent fatigue strength can be obtained by controlling the nonuniformity of the crystal grain size after cold-rolled sheet annealing and also the lowering of the magnetic flux density when grain growth is caused by heat treatment can be suppressed. Specifically, by controlling the area ratio of crystal grains having a grain size of not less than 1.5 times the average crystal grain size to be not less than 10%, the fatigue strength of not less than 450 MPa required for rotor material of HEV/EV motors is satisfied, and lowering of the magnetic flux density by heat treatment can be suppressed. Although the reason why such an effect can be obtained by controlling the nonuniformity of crystal grain size has not been clarified sufficiently, it is presumed that the orientation relation of neighboring crystal grains changes, resulting in that the stress concentration in the vicinity of grain boundaries is mitigated to improve the fatigue strength and the deterioration of the texture by subsequent heat treatment is prevented. Here, a preferable area ratio of crystal grains having a grain size of not less than 1.5 times the average crystal grain size is not less than 15%. The upper limit is not particularly specified, but according to studies by the inventors, is usually not more than 30%.

Crystal Grains Having an Aspect Ratio of not More than 0.3:Not More than 20% in the Area Ratio

When a large number of elongated crystal grains are present in a steel sheet texture of a product sheet, the stress concentration when stress is applied is fostered, causing a lowering of the fatigue strength. According to studies by the inventors, to meet the fatigue strength of not less than 450 MPa required for a rotor material of HEV/EV motors, crystal grains having an aspect ratio of not more than 0.3 need to account for an area ratio of not more than 20%. The area ratio is preferably not more than 10%.

The non-oriented electrical steel sheet after heat treatment described in [3] or [4] will be explained.

Average Crystal Grain Size: Not Less than 120 μm

The iron loss properties of the non-oriented electrical steel sheet vary depending on the average crystal grain size. Accordingly, the steel sheet after the heat treatment according to aspects of the present invention is made to have an average crystal grain size of not less than 120 μm, to attain the iron loss properties required for the stator core; it is preferably not less than 150 μm. Note that, since excessive coarsening may deteriorate iron loss, it is preferable that the upper limit thereof is about 500 μm.

Crystal Grains Having a Grain Size of not Less than 1.5 Times the Average Crystal Grain Size: Not Less than 5% in the Area Ratio

As described before, it has been found that a non-oriented electrical steel sheet having an excellent fatigue strength can be obtained by controlling the nonuniformity of the crystal grain size, and there can be suppressed lowering of the magnetic flux density caused when grain growth is caused by heat treatment. Specifically, in the non-oriented electrical steel sheet according to aspects of the present invention, when the steel sheet texture after grain growth is caused by heat treatment has an area ratio of crystal grains having a crystal grain size of not less than 1.5 times the average crystal grain size being not less than 5%, lowering of the magnetic flux density after heat treatment can be suppressed to the minimum. The area ratio is preferably not less than 10%. The upper limit is not particularly specified, but according to studies by the inventors, is usually not more than 25%.

Here, each of the average crystal grain sizes, the area ratio of crystal grains having a grain size of not less than 1.5 times the average crystal grain size, and the area ratio of crystal grains having an aspect ratio of not more than 0.3 is values acquired by measuring a surface (observation plane) parallel with the steel sheet surface and at the position of ¼ in sheet thickness of the steel sheet by electron backscatter diffractometry (EBSD) and analyzing the measurement by a method described in Examples.

Then, there will be explained a method for producing a non-oriented electrical steel sheet according to aspects of the present invention.

First, a method for producing the non-oriented electrical steel sheet described in [1] or [2] will be explained.

The non-oriented electrical steel sheet described in [1] or [2] according to aspects of the present invention can be produced by

producing a steel raw material having the component composition described in [1] or [2],

hot rolling the steel raw material to form a hot-rolled sheet,

subjecting the hot-rolled sheet to hot-band annealing as required, and

subjecting the steel sheet to pickling, cold rolling, and cold-rolled sheet annealing. The production method will be explained specifically below.

Steel Raw Material

Steel for use in the production of the non-oriented electrical steel sheet described in [1] or [2] according to aspects of the present invention suffices as long as being one controlled to have the above component composition described in [1] or [2]; and a method of manufacturing the steel can adopt a usually well-known refining process using a converter, an electric furnace, a vacuum degassing apparatus or the like, and is not especially limited. The method for producing the steel raw material is preferably a continuous casting process and may use an ingot making-blooming process, a thin slab continuous casting process, or the like.

Hot Rolling

Hot rolling is a step where the steel raw material having the above component composition is subjected to hot rolling to form a hot-rolled sheet having a predetermined sheet thickness. The conditions of the hot rolling are not particularly specified, but examples thereof include a reheating temperature of the steel raw material being not lower than 1,000° C. and not higher than 1,200° C., a finish-rolling end temperature in the hot rolling being not lower than 800° C. and not higher than 950° C., an average cooling rate after the hot rolling being not lower than 20° C./s and not higher than 100° C./s, and a coiling temperature being not lower than 400° C. and not higher than 700° C. as a coiling condition.

Hot-Band Annealing

Hot-band annealing is a step of heating the hot-rolled sheet and holding it at a high temperature to thereby uniform the steel sheet texture. The annealing temperature and the holding time of the hot-band annealing are not particularly limited, but are preferably in the ranges of not lower than 800° C. and not higher than 1,100° C. and not less than 3 seconds and not more than 600 seconds, respectively. Note that the hot-band annealing is not essential and may be omitted.

Pickling

Pickling is a step of descaling the steel sheet after the hot-band annealing or the hot-rolled sheet in the case of omitting the hot-band annealing. The pickling conditions suffice as long as descaling can be carried out to such an extent as to be able to carry out cold rolling, and for example, usual pickling conditions using hydrochloric acid, sulfuric acid, or the like can be applied. The pickling may be carried out continuously after the annealing in a line for the hot-band annealing or may be carried out in another line.

Cold Rolling

Cold rolling is a step of cold rolling the hot-rolled sheet or hot-band annealed sheet having undergone the pickling to the sheet thickness (final sheet thickness) of a product sheet. The cold rolling is not particularly limited as long as the final sheet thickness is achieved. Also, the cold rolling is not limited to one rolling, and, as required, may be carried out twice or more with an intermediate annealing between each rolling. The condition of the intermediate annealing, in this case, may be a usual condition and is not particularly limited.

Cold-Rolled Sheet Annealing

Cold-rolled sheet annealing is a step of performing annealing on the cold-rolled sheet having cold-rolled to the final sheet thickness and is one of the important steps in accordance with aspects of the present invention. The cold-rolled sheet annealing needs to be carried out under such conditions that the cold-rolled sheet is heated to an annealing temperature T₁ between 700 and 850° C. at an average heating rate V₁ between 500° C. and 700° C. in the heating process of not less than 10° C./s, soaked as required, and cooled. Hereinafter, the cold-rolled sheet annealing will be explained specifically.

Average Heating Rate V₁ Between 500° C. and 700° C.: Not Less than 10° C./s

In the case where the average heating rate between 500° C. and 700° C. is low, the recrystallization nucleation frequency is low, and most part of the texture is liable to be occupied by relatively coarse crystal grains, with an area where the recrystallized grains having nucleated at an early stage being as the main part. Hence, the area ratio of crystal grains having a grain size of not less than 1.5 times the average crystal grain size is decreased. On the other hand, in the case where the average heating rate between 500° C. and 700° C. is high, the recrystallization nucleation frequency is high and each grain grows at a different rate to thus increase the proportion of crystal grains having a coarse grain size with respect to a crystal grain having an average size. In particular, in the steel sheet having the component composition conforming to aspects of the present invention, by heating at the average heating rate V₁ between 500° C. and 700° C. of not less than 10° C./s, crystal grains having a crystal grain size of not less than 1.5 times the average crystal grain size can be increased to not less than 10% in the area ratio. The average heating rate is preferably not less than 50° C./s, more preferably not less than 100° C./s, and still more preferably not less than 200° C./s.

Annealing Temperature T₁: Not Lower than 700° C. and not Higher than 850° C.

When the annealing temperature T₁ is lower than 700° C., the growth of recrystallized grains is delayed, and thus the recrystallized grains are suppressed to grow exceeding grain boundaries of crystal grains elongated by the cold rolling, resulting in that the recrystallized grains are liable to stay elongated. Parts of the steel sheet are not recrystallized and some crystal grains elongated by the cold rolling may remain. Consequently, it becomes impossible to have an area ratio of crystal grains having an aspect of not more than 0.3 being not more than 20%. Therefore, in accordance with aspects of the present invention, the annealing temperature T₁ is set to not lower than 700° C., preferably not lower than 750° C. On the other hand, when the annealing temperature T₁ exceeds 850° C., the recrystallized grains grow excessively, making it difficult to have an average crystal grain size of not more than 80 μm. Therefore, the annealing temperature T₁ is set to be not higher than 850° C., preferably not higher than 825° C.

Although the steel sheet after the cold-rolled sheet annealing is usually formed into a product by applying insulation coating on the surface, a method thereof and the kind of the coating are not particularly limited, and a usual insulation coating may be applied suitably according to coating film properties required.

Then, a method for producing the non-oriented electrical steel sheet described in [3] or [4] according to aspects of the present invention will be explained.

The non-oriented electrical steel sheet described in [3] or [4] according to aspects of the present invention can be produced, as described before, by subjecting the non-oriented electrical steel sheet described in [1] or [2] to a heat treatment described below. The heat treatment conditions will be described specifically below.

Annealing Temperature T₂: Not Lower than 750° C. and not Higher than 900° C.

When the annealing temperature T₂ in the heat treatment is lower than 750° C., the grain growth is insufficient, and thus the average crystal grain size of not less than 120 μm cannot be obtained. Therefore, the annealing temperature T₂ is set to be not lower than 750° C., preferably not lower than 775° C. On the other hand, when the annealing temperature T₂ exceeds 900° C., crystal grains grow excessively to result in a homogeneous texture, and thus it becomes difficult to have an area ratio of crystal grains having a crystal grain size of not less than 1.5 times the average crystal grain size of not less than 5%. Hence, the annealing temperature T₂ is not higher than 900° C., preferably not higher than 875° C. The time for holding the annealing temperature is not particularly specified but is preferably in the range of not less than 10 minutes and not more than 500 minutes. The atmosphere in the heat treatment is not also particularly specified, but is preferably a non-oxidizing or reducing atmosphere.

Next, a motor core according to aspects of the present invention and a production method thereof will be explained.

A motor core according to aspects of the present invention comprises a rotor core and a stator core. The rotor core is formed by laminating a rotor core material taken out from the non-oriented electrical steel sheet described in [1] or [2], and the stator core is formed by laminating a stator core material taken out from the non-oriented electrical steel sheet described in [1] or [2] and performing a heat treatment on the stator core material so that the stator core is made of the non-oriented electrical steel sheet in [3] or [4]. A method for producing the rotor core and the stator core may use usual methods, except for taking the rotor core material and the stator core material from the same raw material steel sheet and are not particularly limited.

In the production of a motor core according to aspects of the present invention, however, it is important that the laminated stator core needs to be subjected to the heat treatment to obtain desired magnetic properties. The heat treatment is usually carried out on the stator core after being assembled as a core as described above, but the stator core may be formed by dividing the non-oriented electrical steel sheet described in [1] or [2] and carrying out the heat treatment under the same conditions as above on either one steel sheet, and thereafter taking out the stator core material and laminating the stator core material. Alternatively, the stator core may be assembled by simultaneously taking the rotor core material and the stator core material from the raw material steel sheet described in [1] or [2], and thereafter carrying out the heat treatment under the same conditions as above only on the stator core material and thereafter laminating the stator core material.

### Example 1

Steels having various component compositions indicated in Table 1 were produced by a usual well-known method and continuously cast to each form a slab (steel raw material) of 230 mm in wall thickness, and the slab was hot-rolled to form a hot-rolled sheet of 2.0 mm in sheet thickness. Then, the hot-rolled sheet was subjected to hot-band annealing and pickling by a usual well-known method, and thereafter cold rolled to form a cold-rolled sheet having various thicknesses indicated in Table 2.

Then, the cold-rolled sheet was subjected to cold-rolled sheet annealing under the conditions indicated in Table 2 and thereafter coated with an insulation coating film by a usually well-known method to thereby form a cold-rolled annealed sheet.

Then, the cold-rolled annealed sheet was subjected to heat treatment holding the temperature at an annealing temperature indicated in Table 2 for 1 hour to thereby form a heat treatment sheet.

The cold-rolled annealed sheet and the heat treatment sheet thus obtained were subjected to the following evaluation tests, the results of which are shown together in Table 2.

### <Observation of Structures of the Steel Sheets>

Test specimens for texture observation were taken out from each of the cold-rolled annealed sheets and heat treatment sheets, and the thickness thereof was reduced by chemical polishing so that a plane in the test specimen parallel with the rolled surface (ND plane) and at the position corresponding to ¼ in sheet thickness thereof turns into a mirror-finished observation plane, which was subjected to an electron backscatter diffractometry (EBSD). The measurement conditions were: a step size of 2 μm and a measurement area of 4 mm² for the cold-rolled annealed sheets and a step size of 10 μm and a measurement area of 100 mm² for the heat treatment sheets.

Then, local orientation data were analyzed on the measurement results by using an analysis software: OIM Analysis 8. Before the data analysis, a clean-up process was carried out once by each of the Grain Dilation function (Grain Tolerance Angle: 5°, Minimum Grain Size: 5, Single Iteration: ON) of the analysis software and Grain CI Standardization function (Grain Tolerance Angle: 5°, Minimum Grain Size: 5) thereof, in order, and measurement points having CI values >0.1 only were used for the analysis.

Then, on the condition that Grain Tolerance Angle of the crystal grain boundary was defined as 15°, Area Average of Grain Size (diameter) was determined as an average crystal grain size. Further, the proportion (area ratio) of crystal grains having a crystal grain size of not less than 1.5 times the average crystal grain size and the proportion (area ratio) of crystal grains having an aspect ratio (Grain Shape Aspect Ratio) of not more than 0.3 as defined by OIM Analysis 8 are also determined.

<Evaluation of the Fatigue Property>

Tensile fatigue test specimens (No. 1 test specimen according to JIS Z2275:1978, b: 15 mm, R: 100 mm) having the longitudinal direction in the rolling direction were taken out from each cold-rolled annealed sheet and subjected to fatigue tests under conditions of a pulsating-tension-loading mode, a stress ratio (minimum stress/maximum stress) of 0.1 and a frequency of 20 HZ; and the maximum stress at which no fatigue fracture occurred in a repeating number of 10⁷ was defined as a fatigue limit (fatigue strength). In the evaluation of the fatigue property, the case where the fatigue limit was not less than 450 MPa was evaluated as being excellent in the fatigue property.

<Evaluation of the Magnetic Properties>

Test specimens for magnetic measurement of a width of 30 mm and a length of 180 mm having the longitudinal direction in the rolling direction or the direction orthogonal to rolling were taken out from each of the cold-rolled annealed sheets and heat treatment sheets. The magnetic flux density B₅₀ was measured from the test specimens taken out from the cold-rolled annealed sheets, and the magnetic flux density B₅₀ and the iron loss W_{10/400} were measured from the test specimens taken out from the heat treatment sheets, both by the Epstein method according to JIS C2550-1:2011. Then, the case where the difference ΔB₅₀ in the magnetic flux density B₅₀ between before and after the heat treatment (the magnetic flux density B₅₀ after the heat treatment—the magnetic flux density B₅₀ before the heat treatment) was not less than −0.040T was evaluated as being suppressed in lowering of the magnetic flux density by the heat treatment.

Then, the iron loss properties were evaluated as being excellent in the case where the iron loss W_{10/400} after the heat treatment was not more than 8.8 W/kg for a sheet material with a sheet thickness of 0.10 mm; not more than 10.3 W/kg for a sheet material with a sheet thickness of 0.20 mm; not more than 11.5 W/kg for a sheet material with a sheet thickness of 0.25 mm; not more than 14.7 W/kg for a steel material with a sheet thickness of 0.35 mm; and not more than 21.7 W/kg for a steel material with a sheet thickness of 0.50 mm.

TABLE 1

| Steel | Chemical composition (mass %) | | | | | | | | | | | |
|---|---|---|---|---|---|---|---|---|---|---|---|---|
| symbol | C | Si | Mn | P | S | Al | N | Zn | Cr | Ca | Mg | REM |
| A | 0.0039 | 3.7 | 0.37 | 0.013 | 0.0031 | 0.70 | 0.0018 | 0.0013 | — | — | — | — |
| B | 0.0032 | 4.3 | 1.00 | 0.014 | 0.0040 | 0.02 | 0.0029 | 0.0028 | — | — | — | — |
| C | 0.0007 | 4.1 | 1.90 | 0.017 | 0.0020 | 1.80 | 0.0020 | 0.0014 | — | — | — | — |
| D | 0.0026 | 3.3 | 0.19 | 0.013 | 0.0012 | 2.00 | 0.0018 | 0.0027 | — | — | — | — |
| E | 0.0007 | 4.7 | 1.10 | 0.010 | 0.0012 | 1.60 | 0.0020 | 0.0020 | 4.4 | — | — | 0.009 |
| F | 0.0023 | 3.9 | 0.40 | 0.008 | 0.0029 | 0.70 | 0.0016 | 0.0014 | — | 0.003 | — | — |
| G | 0.0025 | 3.3 | 1.80 | 0.007 | 0.0032 | 1.30 | 0.0027 | 0.0010 | — | — | — | — |
| H | 0.0019 | 3.5 | 0.70 | 0.011 | 0.0016 | 1.10 | 0.0023 | 0.0016 | — | 0.002 | — | — |
| I | 0.0035 | 4.2 | 1.50 | 0.074 | 0.0022 | 0.60 | 0.0030 | 0.0020 | — | — | 0.002 | — |
| J | 0.0030 | 4.3 | 2.80 | 0.013 | 0.0022 | 0.60 | 0.0029 | 0.0026 | — | 0.007 | — | — |
| K | 0.0055 | 3.8 | 0.20 | 0.015 | 0.0008 | 1.00 | 0.0023 | 0.0020 | — | — | — | — |
| L | 0.0023 | 1.9 | 1.60 | 0.017 | 0.0009 | 0.54 | 0.0030 | 0.0025 | — | — | — | — |
| M | 0.0023 | 4.0 | 0.70 | 0.010 | 0.0021 | 0.003 | 0.0015 | 0.0022 | — | — | — | — |
| N | 0.0028 | 3.1 | 0.41 | 0.008 | 0.0017 | 1.30 | 0.0029 | 0.0001 | — | — | — | — |
| O | 0.0043 | 4.2 | 1.60 | 0.020 | 0.0036 | 0.92 | 0.0021 | 0.0025 | — | — | — | — |
| P | 0.0013 | 2.4 | 0.21 | 0.009 | 0.0032 | 1.30 | 0.0020 | 0.0015 | — | — | 0.007 | — |
| Q | 0.0029 | 2.7 | 1.80 | 0.007 | 0.0022 | 0.41 | 0.0017 | 0.0016 | — | — | — | — |
| R | 0.0035 | 3.9 | 3.80 | 0.011 | 0.0011 | 0.42 | 0.0028 | 0.0011 | — | — | — | — |
| S | 0.0014 | 3.3 | 0.06 | 0.011 | 0.0014 | 1.40 | 0.0018 | 0.0013 | 2.0 | — | — | 0.002 |
| T | 0.0011 | 4.6 | 1.30 | 0.092 | 0.0007 | 0.11 | 0.0026 | 0.0016 | — | — | — | — |
| U | 0.0021 | 4.8 | 0.59 | 0.016 | 0.0062 | 1.40 | 0.0024 | 0.0028 | — | — | 0.006 | — |
| V | 0.0022 | 3.3 | 0.53 | 0.013 | 0.0020 | 2.60 | 0.0015 | 0.0026 | 2.1 | — | — | — |
| W | 0.0035 | 3.7 | 0.53 | 0.006 | 0.0025 | 0.008 | 0.0029 | 0.0014 | — | — | — | — |
| X | 0.0019 | 4.1 | 1.57 | 0.015 | 0.0020 | 0.013 | 0.0015 | 0.0021 | — | — | — | — |
| Y | 0.0040 | 4.7 | 1.70 | 0.014 | 0.0012 | 1.80 | 0.0022 | 0.0024 | — | — | — | 0.003 |
| Z | 0.0031 | 4.0 | 2.00 | 0.020 | 0.0033 | 0.31 | 0.0030 | 0.0004 | — | — | — | — |
| AA | 0.0007 | 4.0 | 0.60 | 0.018 | 0.0028 | 0.07 | 0.0027 | 0.0008 | — | — | — | — |
| AB | 0.0008 | 4.8 | 1.20 | 0.017 | 0.0007 | 1.40 | 0.0017 | 0.0024 | 4.6 | — | — | — |
| AC | 0.0011 | 4.6 | 0.67 | 0.007 | 0.0007 | 0.49 | 0.0029 | 0.0025 | — | 0.002 | — | — |
| AD | 0.0030 | 3.4 | 0.44 | 0.005 | 0.0013 | 1.90 | 0.0022 | 0.0024 | — | — | 0.008 | — |
| AE | 0.0020 | 3.9 | 1.50 | 0.019 | 0.0006 | 1.00 | 0.0020 | 0.0012 | — | — | — | 0.009 |
| AF | 0.0019 | 3.3 | 1.70 | 0.015 | 0.0005 | 1.50 | 0.0030 | 0.0028 | — | — | — | — |
| AG | 0.0015 | 4.9 | 2.00 | 0.018 | 0.0015 | 0.71 | 0.0024 | 0.0024 | — | — | — | — |
| AH | 0.0031 | 3.0 | 0.40 | 0.020 | 0.0036 | 3.10 | 0.0023 | 0.0011 | — | — | — | — |
| AI | 0.0039 | 3.6 | 1.40 | 0.014 | 0.0022 | 1.05 | 0.0029 | 0.0065 | — | — | — | — |
| AJ | 0.0038 | 3.6 | 0.20 | 0.019 | 0.0024 | 0.34 | 0.0023 | 0.0027 | — | — | — | — |
| AK | 0.0030 | 3.5 | 0.20 | 0.011 | 0.0033 | 0.73 | 0.0018 | 0.0014 | — | — | — | — |
| AL | 0.0027 | 3.7 | 1.30 | 0.012 | 0.0011 | 1.05 | 0.0017 | 0.0021 | — | — | — | — |
| AM | 0.0006 | 3.3 | 1.10 | 0.005 | 0.0029 | 1.97 | 0.0024 | 0.0010 | — | — | — | — |
| AN | 0.0033 | 3.5 | 1.70 | 0.018 | 0.0040 | 0.06 | 0.0022 | 0.0030 | — | — | — | — |

| Steel | Chemical composition (mass %) | | | | | | | |
|---|---|---|---|---|---|---|---|---|
| symbol | Sn | Sb | Ni | Cu | Nb | Ti | V | Remarks |
| A | — | — | — | — | — | — | — | Inventive steel |
| B | — | — | — | — | — | — | — | Inventive steel |
| C | — | — | — | — | — | — | — | Inventive steel |
| D | — | — | — | — | — | — | — | Inventive steel |
| E | 0.18 | — | — | — | — | — | — | Inventive steel |
| F | 0.03 | — | — | — | — | — | — | Inventive steel |
| G | 0.03 | — | — | — | — | — | — | Inventive steel |
| H | 0.05 | — | — | — | — | — | — | Inventive steel |
| I | — | — | — | — | — | — | — | Inventive steel |
| J | — | 0.04 | — | — | — | — | — | Inventive steel |
| K | — | — | — | — | — | — | — | Comparative steel |
| L | — | — | — | — | — | — | — | Comparative steel |
| M | — | — | — | — | — | — | — | Inventive steel |
| N | — | — | — | — | — | — | — | Comparative steel |
| O | — | — | — | — | — | — | — | Inventive steel |
| P | — | 0.003 | — | — | — | — | — | Inventive steel |
| Q | — | — | — | — | — | — | — | Inventive steel |
| R | 0.01 | — | — | — | — | — | — | Inventive steel |
| S | — | — | — | — | — | — | — | Inventive steel |
| T | — | 0.05 | — | — | — | — | — | Inventive steel |
| U | — | — | — | — | — | — | — | Inventive steel |
| V | 0.13 | — | — | — | — | — | — | Inventive steel |
| W | — | 0.13 | — | — | — | — | — | Inventive steel |
| X | — | — | — | — | — | — | — | Inventive steel |
| Y | — | — | — | — | — | — | — | Inventive steel |
| Z | — | — | — | — | — | — | — | Inventive steel |
| AA | 0.06 | — | — | — | — | — | — | Inventive steel |
| AB | — | — | — | — | — | — | — | Inventive steel |
| AC | — | — | — | — | — | — | — | Inventive steel |
| AD | — | — | — | — | — | — | — | Inventive steel |
| AE | — | — | — | — | — | — | — | Inventive steel |
| AF | 0.15 | — | — | — | — | — | — | Inventive steel |
| AG | — | 0.11 | — | — | — | — | — | Inventive steel |
| AH | — | — | — | — | — | — | — | Comparative steel |
| AL | — | — | — | — | — | — | — | Comparative steel |
| AJ | — | — | 0.20 | — | — | — | — | Inventive steel |
| AK | — | — | — | 0.11 | — | — | — | Inventive steel |
| AL | — | — | — | — | 0.022 | — | — | Inventive steel |
| AM | — | — | — | — | — | — | 0.054 | Inventive steel |
| AN | — | — | — | — | — | 0.019 | — | Inventive steel |

TABLE 2

| | | | | | Properties of cold-rolled annealed sheet | | | | |
|---|---|---|---|---|---|---|---|---|---|
| | | | Cold-rolled sheet | | | Area ratio of | | | |
| | | | annealing | | | crystal grains | | | |
| | | | Average | | | having a grain | Area ratio of | | |
| | | | heating rate | | Average | size of not | crystal grains | | |
| | | | between | | crystal | less than 1.5 | having an | Fatigue | Magnetic |
| | | Steel | 500 and | Annealing | grain | times the | aspect ratio | limit | flux |
| | Steel | thickness | 700° C., | temperature | size | average crystal | of not more | σₘₐₓ | density |
| No. | symbol | (mm) | V₁ (° C./s) | T₁ (° C.) | (μm) | grain size (%) | than 0.3 (%) | (MPa) | B₅₀ (T) |
| 1 | A | 0.25 | 50 | 820 | 57 | 18 | 4 | 530 | 1.666 |
| 2 | B | 0.25 | 50 | 780 | 35 | 15 | 2 | 530 | 1.661 |
| 3 | C | 0.35 | 50 | 770 | 38 | 16 | 4 | 580 | 1.615 |
| 4 | D | 0.35 | 50 | 770 | 35 | 15 | 2 | 570 | 1.642 |
| 5 | E | 0.50 | 200 | 800 | 45 | 20 | 2 | 580 | 1.479 |
| 6 | F | 0.25 | 200 | 820 | 51 | 21 | 3 | 560 | 1.669 |
| 7 | G | 0.25 | 200 | 770 | 42 | 19 | 3 | 540 | 1.675 |
| 8 | H | 0.20 | 200 | 760 | 35 | 19 | 3 | 550 | 1.672 |
| 9 | I | 0.20 | 500 | 790 | 45 | 20 | 3 | 550 | 1.650 |
| 10 | J | 0.10 | 500 | 820 | 62 | 25 | 3 | 550 | 1.656 |
| 11 | K | 0.25 | 60 | 760 | 29 | 15 | 3 | 560 | 1.652 |
| 12 | L | 0.25 | 60 | 790 | 51 | 16 | 3 | 480 | 1.741 |
| 13 | M | 0.25 | 60 | 750 | 32 | 13 | 1 | 460 | 1.666 |
| 14 | N | 0.25 | 60 | 800 | 44 | 8 | 1 | 420 | 1.671 |
| 15 | O | 0.25 | 80 | 810 | 54 | 17 | 3 | 560 | 1.639 |
| 16 | P | 0.25 | 80 | 760 | 27 | 15 | 1 | 500 | 1.700 |
| 17 | Q | 0.25 | 80 | 760 | 27 | 16 | 2 | 520 | 1.714 |
| 18 | R | 0.35 | 80 | 820 | 65 | 19 | 1 | 530 | 1.666 |
| 19 | S | 0.35 | 80 | 780 | 33 | 16 | 4 | 540 | 1.603 |
| 20 | T | 0.35 | 120 | 790 | 44 | 19 | 3 | 560 | 1.646 |
| 21 | U | 0.35 | 120 | 770 | 36 | 16 | 2 | 590 | 1.602 |
| 22 | V | 0.50 | 120 | 800 | 47 | 17 | 2 | 560 | 1.562 |
| 23 | W | 0.50 | 120 | 820 | 57 | 12 | 3 | 460 | 1.685 |
| 24 | X | 0.25 | 120 | 820 | 59 | 12 | 3 | 460 | 1.669 |
| 25 | Y | 0.25 | 120 | 780 | 36 | 17 | 2 | 580 | 1.592 |
| 26 | Z | 0.10 | 120 | 770 | 41 | 12 | 4 | 450 | 1.665 |
| 27 | AA | 0.20 | 120 | 820 | 51 | 12 | 3 | 460 | 1.672 |
| 28 | AB | 0.20 | 400 | 780 | 36 | 19 | 3 | 580 | 1.464 |
| 29 | AC | 0.25 | 400 | 780 | 42 | 19 | 3 | 580 | 1.638 |
| 30 | AD | 0.25 | 400 | 750 | 24 | 18 | 2 | 540 | 1.644 |
| 31 | AE | 0.35 | 50 | 820 | 57 | 17 | 4 | 560 | 1.647 |
| 32 | AF | 0.35 | 50 | 820 | 56 | 18 | 4 | 570 | 1.667 |
| 33 | AG | 0.50 | 50 | 780 | 44 | 19 | 4 | 560 | 1.627 |
| 34 | AH | 0.25 | 120 | 800 | 52 | 17 | 4 | 560 | 1.620 |
| 35 | AI | Fractured during cold rolling | | | | | | | |
| 36 | AJ | 0.25 | 100 | 810 | 56 | 19 | 2 | 550 | 1.689 |
| 37 | AK | 0.25 | 100 | 790 | 47 | 18 | 3 | 530 | 1.671 |
| 38 | AL | 0.25 | 100 | 790 | 39 | 17 | 2 | 560 | 1.654 |
| 39 | AM | 0.25 | 100 | 790 | 50 | 17 | 2 | 550 | 1.643 |
| 40 | AN | 0.25 | 100 | 750 | 21 | 16 | 1 | 530 | 1.692 |
| 41 | A | 0.25 | 200 | 680 | 32 | 15 | 25 | 430 | 1.668 |
| 42 | A | 0.25 | 200 | 730 | 24 | 16 | 13 | 470 | 1.669 |
| 43 | A | 0.25 | 200 | 860 | 93 | 21 | 1 | 440 | 1.667 |
| 44 | A | 0.25 | 200 | 840 | 71 | 21 | 2 | 460 | 1.668 |
| 45 | B | 0.25 | 200 | 810 | 65 | 19 | 4 | 530 | 1.663 |
| 46 | C | 0.35 | 200 | 810 | 63 | 19 | 3 | 590 | 1.617 |
| 47 | D | 0.25 | 200 | 770 | 33 | 27 | 3 | 570 | 1.644 |
| 48 | D | 0.35 | 200 | 800 | 54 | 16 | 2 | 550 | 1.643 |
| 49 | E | 0.50 | 200 | 810 | 57 | 13 | 2 | 570 | 1.469 |
| 50 | F | 0.25 | 500 | 770 | 48 | 18 | 1 | 540 | 1.660 |
| 51 | G | 0.25 | 800 | 810 | 56 | 22 | 4 | 530 | 1.666 |
| 52 | H | 0.20 | 800 | 770 | 45 | 21 | 3 | 540 | 1.663 |

| | | Properties of heat treatment sheet | | | | | |
|---|---|---|---|---|---|---|---|
| | | | Area ratio of | | | Difference in | |
| | | | crystal grains | | | magnetic flux | |
| | | | having a grain | | | density B₅₀ | |
| | Heat | Average | size of not | | | between | |
| | treatment | crystal | less than 1.5 | Magnetic | Iron | before and | |
| | Annealing | grain | times the | flux | loss | after heat | |
| | temperature | size | average crystal | density | W_{10/400} | treatment, | |
| No. | T₂ (° C.) | (μm) | grain size (%) | B₅₀(T) | (W/kg) | ΔB₅₀ (T) | Remarks |
| 1 | 870 | 240 | 16 | 1.643 | 10.1 | −0.023 | Inventive Example |
| 2 | 780 | 153 | 13 | 1.633 | 10.0 | −0.028 | Inventive Example |
| 3 | 790 | 165 | 13 | 1.587 | 10.4 | −0.028 | Inventive Example |
| 4 | 810 | 185 | 12 | 1.614 | 12.3 | −0.028 | Inventive Example |
| 5 | 810 | 182 | 18 | 1.464 | 17.9 | −0.015 | Inventive Example |
| 6 | 790 | 170 | 19 | 1.656 | 9.7 | −0.013 | Inventive Example |
| 7 | 870 | 248 | 17 | 1.656 | 8.0 | −0.019 | Inventive Example |
| 8 | 820 | 196 | 17 | 1.654 | 9.5 | −0.018 | Inventive Example |
| 9 | 810 | 185 | 18 | 1.635 | 8.8 | −0.015 | Inventive Example |
| 10 | 830 | 196 | 23 | 1.649 | 6.1 | −0.008 | Inventive Example |
| 11 | 840 | 231 | 13 | 1.623 | 11.6 | −0.028 | Comparative Example |
| 12 | 860 | 248 | 14 | 1.714 | 12.3 | −0.027 | Comparative Example |
| 13 | 870 | 247 | 11 | 1.632 | 11.1 | −0.034 | Inventive Example |
| 14 | 830 | 206 | 6 | 1.628 | 10.9 | −0.042 | Comparative Example |
| 15 | 860 | 236 | 15 | 1.615 | 9.1 | −0.024 | Inventive Example |
| 16 | 860 | 231 | 13 | 1.673 | 11.4 | −0.027 | Inventive Example |
| 17 | 830 | 226 | 13 | 1.686 | 10.9 | −0.028 | Inventive Example |
| 18 | 790 | 189 | 17 | 1.643 | 11.7 | −0.022 | Inventive Example |
| 19 | 790 | 177 | 14 | 1.578 | 14.3 | −0.025 | Inventive Example |
| 20 | 860 | 228 | 16 | 1.625 | 12.4 | −0.021 | Inventive Example |
| 21 | 830 | 214 | 14 | 1.576 | 13.0 | −0.026 | Inventive Example |
| 22 | 850 | 219 | 15 | 1.540 | 19.2 | −0.022 | Inventive Example |
| 23 | 810 | 206 | 10 | 1.649 | 20.6 | −0.036 | Inventive Example |
| 24 | 870 | 236 | 10 | 1.633 | 9.8 | −0.036 | Inventive Example |
| 25 | 830 | 223 | 15 | 1.568 | 8.3 | −0.023 | Inventive Example |
| 26 | 780 | 158 | 10 | 1.629 | 6.3 | −0.036 | Inventive Example |
| 27 | 850 | 226 | 9 | 1.635 | 9.3 | −0.037 | Inventive Example |
| 28 | 820 | 189 | 16 | 1.448 | 6.2 | −0.016 | Inventive Example |
| 29 | 800 | 173 | 17 | 1.619 | 10.2 | −0.019 | Inventive Example |
| 30 | 860 | 226 | 15 | 1.623 | 9.7 | −0.021 | Inventive Example |
| 31 | 790 | 167 | 15 | 1.623 | 11.9 | −0.024 | Inventive Example |
| 32 | 790 | 177 | 16 | 1.647 | 11.1 | −0.020 | Inventive Example |
| 33 | 830 | 204 | 16 | 1.605 | 17.3 | −0.022 | Inventive Example |
| 34 | 820 | 221 | 14 | 1.600 | 11.8 | −0.021 | Comparative Example |
| 35 | Fractured during cold rolling | | | | | | Comparative Example |
| 36 | 870 | 243 | 16 | 1.669 | 10.8 | −0.021 | Inventive Example |
| 37 | 830 | 161 | 15 | 1.648 | 11.4 | −0.023 | Inventive Example |
| 38 | 820 | 158 | 14 | 1.632 | 11.2 | −0.023 | Inventive Example |
| 39 | 830 | 162 | 15 | 1.619 | 10.9 | −0.024 | Inventive Example |
| 40 | 820 | 164 | 14 | 1.664 | 11.3 | −0.027 | Inventive Example |
| 41 | 820 | 213 | 12 | 1.637 | 10.3 | −0.031 | Comparative Example |
| 42 | 850 | 219 | 13 | 1.642 | 9.8 | −0.026 | Inventive Example |
| 43 | 830 | 207 | 18 | 1.655 | 10.0 | −0.012 | Comparative Example |
| 44 | 840 | 231 | 19 | 1.652 | 9.5 | −0.016 | Inventive Example |
| 45 | 730 | 111 | 16 | 1.644 | 11.8 | −0.018 | Comparative Example |
| 46 | 760 | 148 | 16 | 1.599 | 12.8 | −0.018 | Inventive Example |
| 47 | 820 | 199 | 25 | 1.621 | 9.1 | −0.023 | Inventive Example |
| 48 | 920 | 289 | 4 | 1.599 | 13.1 | −0.044 | Comparative Example |
| 49 | 890 | 260 | 6 | 1.433 | 18.5 | −0.036 | Inventive Example |
| 50 | 800 | 180 | 16 | 1.641 | 10.5 | −0.018 | Inventive Example |
| 51 | 810 | 190 | 19 | 1.655 | 8.9 | −0.011 | Inventive Example |
| 52 | 830 | 224 | 19 | 1.647 | 8.3 | −0.016 | Inventive Example |

### Example 2

Each slab (steel raw material) of steel symbol A, M, and N having a different Al content and Zn content indicated in Table 1 was hot rolled to thereby form a hot-rolled sheet of 2.0 mm in sheet thickness under the same conditions as in Example 1, subjected to hot-band annealing and pickling, and thereafter cold-rolled to thereby form a cold-rolled sheet of 0.25 mm in sheet thickness.

Then, the cold-rolled sheet was subjected to cold-rolled sheet annealing under the conditions indicated in Table 3 and thereafter coated with an insulation coating film to thereby form a cold-rolled annealed sheet. In this treatment, the average heating rate between 500 and 700° C. was variously changed in the heating process of the cold-rolled sheet annealing.

Then, the cold-rolled annealed sheet was subjected to heat treatment holding the temperature at an annealing temperature indicated in Table 3 for 1 hour to thereby form a heat treatment sheet.

The cold-rolled annealed sheet and heat treatment sheet thus obtained were subjected to evaluation tests of the texture observation, the fatigue property, and the magnetic properties of the steel sheets, as in Example 1. The results are shown together in Table 3 and shown in the FIGURE. These results reveal that when cold-rolled sheet annealing is carried out under suitable conditions, the addition of Zn alone suppresses the deterioration of the magnetic flux density caused by the heat treatment, and the addition of Zn+Al in combination further suppresses the deterioration of the magnetic flux density caused by the heat treatment.

TABLE 3

| | | | | | Properties of cold-rolled annealed sheet | | | | |
|---|---|---|---|---|---|---|---|---|---|
| | | | Cold-rolled sheet | | | Area ratio of | | | |
| | | | annealing | | | crystal grains | | | |
| | | | Average | | | having a grain | Area ratio of | | |
| | | | heating rate | | Average | size of not | crystal grains | | |
| | | | between | | crystal | less than 1.5 | having an | Fatigue | Magnetic |
| | | Steel | 500 and | Annealing | grain | times the | aspect ratio | limit | flux |
| | Steel | thickness | 700° C., | temperature | size | average crystal | of not more | σₘₐₓ | density |
| No. | symbol | (mm) | V₁ (° C./s) | T₁ (° C.) | (μm) | grain size(%) | than 0.3 (%) | (MPa) | B₅₀(T) |
| 1 | A | 0.25 | 5 | 790 | 48 | 9 | 1 | 430 | 1.662 |
| 2 | A | 0.25 | 15 | 790 | 50 | 15 | 3 | 530 | 1.664 |
| 3 | A | 0.25 | 60 | 790 | 53 | 16 | 3 | 560 | 1.667 |
| 4 | A | 0.25 | 110 | 790 | 50 | 17 | 3 | 550 | 1.667 |
| 5 | A | 0.25 | 250 | 790 | 59 | 21 | 3 | 550 | 1.668 |
| 6 | M | 0.25 | 5 | 790 | 57 | 9 | 3 | 440 | 1.664 |
| 7 | M | 0.25 | 15 | 790 | 51 | 12 | 4 | 460 | 1.665 |
| 8 | M | 0.25 | 60 | 790 | 54 | 13 | 1 | 490 | 1.667 |
| 9 | M | 0.25 | 110 | 790 | 60 | 14 | 2 | 480 | 1.667 |
| 10 | M | 0.25 | 250 | 790 | 54 | 14 | 2 | 480 | 1.667 |
| 11 | N | 0.25 | 5 | 790 | 60 | 8 | 1 | 430 | 1.662 |
| 12 | N | 0.25 | 15 | 790 | 51 | 9 | 1 | 440 | 1.662 |
| 13 | N | 0.25 | 60 | 790 | 48 | 8 | 1 | 420 | 1.664 |
| 14 | N | 0.25 | 110 | 790 | 59 | 9 | 2 | 440 | 1.663 |
| 15 | N | 0.25 | 250 | 790 | 60 | 8 | 2 | 420 | 1.664 |

| | | Properties of heat treatment sheet | | | | | |
|---|---|---|---|---|---|---|---|
| | | | Area ratio of | | | Difference in | |
| | | | crystal grains | | | magnetic flux | |
| | | | having a grain | | | density | |
| | Heat | Average | size of not | | | B₅₀ between | |
| | treatment | crystal | less than 1.5 | Magnetic | Iron | before and | |
| | Annealing | grain | times the | flux | loss | after heat | |
| | temperature | size | average crystal | density | W_{10/400} | treatment, | |
| No. | T₂ (° C.) | (μm) | grain size(%) | B₅₀(T) | (W/kg) | ΔB₅₀ (T) | Remarks |
| 1 | 830 | 214 | 6 | 1.621 | 11.3 | −0.041 | Comparative Example |
| 2 | 830 | 224 | 13 | 1.632 | 9.6 | −0.032 | Inventive Example |
| 3 | 830 | 197 | 13 | 1.641 | 10.3 | −0.026 | Inventive Example |
| 4 | 830 | 213 | 15 | 1.643 | 10.2 | −0.024 | Inventive Example |
| 5 | 830 | 213 | 18 | 1.650 | 10.4 | −0.018 | Inventive Example |
| 6 | 830 | 207 | 6 | 1.622 | 11.0 | −0.042 | Comparative Example |
| 7 | 830 | 226 | 10 | 1.628 | 9.8 | −0.037 | Inventive Example |
| 8 | 830 | 209 | 11 | 1.633 | 10.1 | −0.034 | Inventive Example |
| 9 | 830 | 219 | 11 | 1.635 | 10.5 | −0.032 | Inventive Example |
| 10 | 830 | 206 | 12 | 1.637 | 10.7 | −0.030 | Inventive Example |
| 11 | 830 | 221 | 6 | 1.620 | 10.1 | −0.042 | Comparative Example |
| 12 | 830 | 226 | 7 | 1.620 | 9.7 | −0.042 | Comparative Example |
| 13 | 830 | 194 | 6 | 1.621 | 10.1 | −0.043 | Comparative Example |
| 14 | 830 | 194 | 6 | 1.622 | 11.2 | −0.041 | Comparative Example |
| 15 | 830 | 194 | 6 | 1.622 | 11.0 | −0.042 | Comparative Example |

### INDUSTRIAL APPLICABILITY

The technique according to aspects of the present invention can be applied not only to HEV/EV motors but also to high-efficiency air conditioner motors, main spindle motors of machine tools, and high-speed motors such as railway motors.

1. A non-oriented electrical steel sheet,
characterized that
the non-oriented electrical steel sheet has
a component composition comprising C: not more than 0.005 mass %, Si: not less than 2.0 mass % and not more than 5.0 mass %, Mn: not less than 0.05 mass % and not more than 5.0 mass %, P: not more than 0.1 mass %, S: not more than 0.01 mass %, Al: not more than 3.0 mass %, N: not more than 0.0050 mass %, Zn: not less than 0.0003 mass % and not more than 0.0050 mass %, and the residue being Fe and inevitable impurities,
an average crystal grain size of not more than 80 μm,
an area ratio of crystal grains having a grain size of not less than 1.5 times the average crystal grain size being not less than 10%, and
an area ratio of crystal grains having an aspect ratio of not more than 0.3 being not more than 20%.

2. The non-oriented electrical steel sheet according to claim 1, wherein
the non-oriented electrical steel sheet further comprises, in addition to the above component composition, at least one component group selected from the following Groups A to E:
Group A; Cr: not less than 0.1 mass % and not more than 5.0 mass %;
Group B; one or two or more of Ca: not less than 0.001 mass % and not more than 0.01 mass %, Mg: not less than 0.001 mass % and not more than 0.01 mass %, and REM: not less than 0.001 mass % and not more than 0.01 mass %;
Group C; one or two of Sn: not less than 0.001 mass % and not more than 0.2 mass %, and Sb: not less than 0.001 mass % and not more than 0.2 mass %;
Group D; Ni: not less than 0.01 mass % and not more than 3.0 mass %; and
Group E; one or two or more of Cu: not less than 0.05 mass % and not more than 0.5 mass %, Nb: not less than 0.003 mass % and not more than 0.05 mass %, Ti: not less than 0.003 mass % and not more than 0.05 mass %, and V: not less than 0.010 mass % and not more than 0.20 mass %.

3. A non-oriented electrical steel sheet, characterized in that
the non-oriented electrical steel sheet has
a component composition comprising C: not more than 0.005 mass %, Si: not less than 2.0 mass % and not more than 5.0 mass %, Mn: not less than 0.05 mass % and not more than 5.0 mass %, P: not more than 0.1 mass %, S: not more than 0.01 mass %, Al: not more than 3.0 mass %, N: not more than 0.0050 mass %, Zn: not less than 0.0003 mass % and not more than 0.0050 mass %, and the residue being Fe and inevitable impurities,
an average crystal grain size being not less than 120 μm, and
an area ratio of crystal grains having a grain size of not less than 1.5 times the average crystal grain size being not less than 5%.

4. The non-oriented electrical steel sheet according to claim 3, wherein
the non-oriented electrical steel sheet further comprises, in addition to the above component composition, at least one component group selected from the following Groups A to E:
Group A; Cr: not less than 0.1 mass % and not more than 5.0 mass %;
Group B; one or two or more of Ca: not less than 0.001 mass % and not more than 0.01 mass %, Mg: not less than 0.001 mass % and not more than 0.01 mass %, and REM: not less than 0.001 mass % and not more than 0.01 mass %;
Group C; one or two of Sn: not less than 0.001 mass % and not more than 0.2 mass %, and Sb: not less than 0.001 mass % and not more than 0.2 mass %;
Group D; Ni: not less than 0.01 mass % and not more than 3.0 mass %; and
Group E; one or two or more of Cu: not less than 0.05 mass % and not more than 0.5 mass %, Nb: not less than 0.003 mass % and not more than 0.05 mass %, Ti: not less than 0.003 mass % and not more than 0.05 mass %, and V: not less than 0.010 mass % and not more than 0.20 mass %.

5. A method for producing a non-oriented electrical steel sheet comprising
hot rolling a steel raw material having a component composition comprising C: not more than 0.005 mass %, Si: not less than 2.0 mass % and not more than 5.0 mass %, Mn: not less than 0.05 mass % and not more than 5.0 mass %, P: not more than 0.1 mass %, S: not more than 0.01 mass %, Al: not more than 3.0 mass %, N: not more than 0.0050 mass %, Zn: not less than 0.0003 mass % and not more than 0.0050 mass %, and the residue being Fe and inevitable impurities to form a hot-rolled sheet;
pickling and cold rolling the hot-rolled sheet to form a cold-rolled sheet; and
subjecting the cold-rolled sheet to cold-rolled sheet annealing, wherein
the steel sheet is heated to an annealing temperature T₁ between 700° C. and 850° C. at an average heating rate V₁ of not less than 10° C./s from 500° C. to 700° C. in a heating process of the cold-rolled sheet annealing and cooled, so that the non-oriented electrical steel sheet has an average crystal grain size of not more than 80 μm, an area ratio of crystal grains having a grain size of not less than 1.5 times the average crystal grain size of 10%, and an area ratio of crystal grains having an aspect ratio of not more than 0.3 being not more than 20%.

6. The method for producing a non-oriented electrical steel sheet according to claim 5, wherein
the steel raw material further comprises, in addition to the above component composition, at least one component group selected from following Groups A to E:
Group A; Cr: not less than 0.1 mass % and not more than 5.0 mass %;
Group B; one or two or more of Ca: not less than 0.001 mass % and not more than 0.01 mass %, Mg: not less than 0.001 mass % and not more than 0.01 mass %, and REM: not less than 0.001 mass % and not more than 0.01 mass %;
Group C; one or two of Sn: not less than 0.001 mass % and not more than 0.2 mass %, and Sb: not less than 0.001 mass % and not more than 0.2 mass %;
Group D; Ni: not less than 0.01 mass % and not more than 3.0 mass %; and
Group E; one or two or more of Cu: not less than 0.05 mass % and not more than 0.5 mass %, Nb: not less than 0.003 mass % and not more than 0.05 mass %, Ti: not less than 0.003 mass % and not more than 0.05 mass %, and V: not less than 0.010 mass % and not more than 0.20 mass %.

7. A method for producing a non-oriented electrical steel sheet, characterized in that
the non-oriented electrical steel sheet after the cold-rolled sheet annealing according to claim 5 is subjected to a heat treatment comprising heating to an annealing temperature T₂ between 750 to 900° C. and holding the annealing temperature thus to have an average crystal grain size of not less than 120 μm, and an area ratio of crystal grains having a grain size of not less than 1.5 times the average crystal grain size being not less than 5%.

8. A motor core comprising a rotor core constituted of the non-oriented electrical steel sheet according to claim 1.

9. A method for producing a non-oriented electrical steel sheet, characterized in that
the non-oriented electrical steel sheet after the cold-rolled sheet annealing according to claim 6 is subjected to a heat treatment comprising heating to an annealing temperature T₂ between 750 to 900° C. and holding the annealing temperature thus to have an average crystal grain size of not less than 120 μm, and an area ratio of crystal grains having a grain size of not less than 1.5 times the average crystal grain size being not less than 5%.

10. A motor core comprising a rotor core constituted of the non-oriented electrical steel sheet according to claim 2.

11. A motor core comprising a stator core constituted of the non-oriented electrical steel sheet according to claim 3.

12. A motor core comprising a stator core constituted of the non-oriented electrical steel sheet according to claim 4.
